(19) United States
(12) Patent Application Publication
(10) Pub. No.: US 2019/0108308 A1
(43) Pub. Date: Apr. 11, 2019

(54) METHOD OF SEQUENCE TYPING WITH IN SILICO APTAMERS FROM A NEXT GENERATION SEQUENCING PLATFORM

(71) Applicant: Aagey Holding, LLC, Atlanta, GA (US)

(72) Inventors: Hector ESPITIA, Atlanta, GA (US); Aroon T. CHANDE, Atlanta, GA (US); Irving King JORDAN, Atlanta, GA (US); Lavanya RISHISHWAR, Atlanta, GA (US)

(21) Appl. No.: 15/726,005

(22) Filed: Oct. 5, 2017

(51) Int. Cl. G06F 19/18; G06F 19/16; G06F 19/28

(52) U.S. Cl. CPC G06F 19/18; G06F 19/28; G06F 19/16

(57) ABSTRACT

A method of sequence typing with in silico aptamers from a next generation sequencing (NGS) platform includes a database indexing phase and a sequence variant detection phase. The database indexing phase includes breaking down each of a plurality of input sequences into k-mers, where the k-mers are subsequences of a length k, where the length k is a user defined positive integer, and constructing an enhanced suffix array (ESA) index out of each k-mer from the plurality of input sequences. The sequence variant detection phase includes using an input NGS read file with a plurality of reads. Wherein, the sequence variant detection phase includes using the ESA index constructed out of each k-mer from the plurality of input sequences from the database indexing phase for sequence variant detection.

### FIELD OF THE INVENTION

The present invention relates to sequence typing, like DNA sequence typing. More specifically, the present invention relates to a method of sequence typing with in silico aptamers from a next generation sequencing (NGS) platform.

### BACKGROUND

In silico is Latin for “in silicon”, alluding to the mass use of silicon for semiconductor computer chips. Accordingly, in silico is an expression used to mean performed on a computer or via computer simulation. Aptamers are oligonucleotide or peptide molecules that bind to a specific target molecule. Synonyms for aptamers may include, but are not limited to, substrings, subsequences, K-mers, DNA words, N-grams, the like, etc. Aptamers are usually created by selecting them from a large random sequence pool, but natural aptamers also exist in riboswitches. Aptamers can be classified as: DNA or RNA or XNA aptamers (these consist of usually short strands of oligonucleotides); and Peptide aptamers (these consist of one, or more, short variable peptide domains, attached at both ends to a protein scaffold).

Accordingly, the instant disclosure is related to gene identification and/or microbial typing with in silico aptamers, or computer simulated aptamers, substrings, subsequences, K-mers, DNA words, N-grams, the like, etc. This type of gene identification and/or microbial typing may be known as dry lab gene identification and/or microbial typing. A dry lab is a laboratory where computational or applied mathematical analyses are done on a computer-generated model to simulate a phenomenon in the physical realm.

In computational biology, gene identification refers to the process of identifying the regions of genomic DNA that encode genes. This includes protein-coding genes as well as RNA genes, but may also include prediction of other functional elements such as regulatory regions. Gene identification may be one of the first and most important steps in understanding the genome of a species once it has been sequenced. Gene prediction or gene finding may be the process of finding genes (novel or previously known) and their (sometimes approximate) location on a genome. The instant disclosure may be directed to identifying genes that have been previously sequenced without trying to find where does the gene reside in this new genome (i.e. it's a more binary type prediction where the gene, or its variant, is either present in this said genome or not). For example, this type of identification may be of prime importance for epidemiological (or biodefense) surveillance, like trying to find if some antimicrobial resistance (AMR) genes are present in a select agent. This may include generating the AMR profile for the genome using which of the right course of actions that could be adopted.

Gene finding was originally based on meticulous experimentation on living cells and organisms. Statistical analysis of the rates of homologous recombination of several different genes could determine their order on a certain chromosome, and information from many such experiments could be combined to create a genetic map specifying the rough location of known genes relative to each other. Today, with comprehensive genome sequences and powerful computational resources at the disposal of the research community, gene finding has been redefined as a largely computational problem. Predicting the function of a gene and confirming that the gene prediction is accurate previously demanded in vivo experimentation through gene knockout and other assays. However, bioinformatics research may be making it increasingly possible to predict the function of a gene based on its sequence alone.

DNA sequencing is the process of determining the precise order of nucleotides within a DNA molecule. The high demand for low-cost sequencing has driven the development of high-throughput sequencing, which also goes by the term next generation sequencing (NGS), or next generation sequencing (NGS) platforms. Thousands or millions of sequences are concurrently produced in a single next-generation sequencing process. NGS has become more and more common with the commercialization of various affordable desktop sequencers. As such, NGS has become within the reach of traditional wet-lab biologists. As seen in recent years, genome-wide scale computational analysis is increasingly being used as a backbone to foster novel discovery in biomedical research.

One problem associated with the recent growth in quantities of NGS data increase is the time and resources, or computational power, required for sequence typing, including but not limited to, gene identification and/or microbial typing. Currently, this type of sequence typing, like gene identification and/or microbial typing, requires time and resource consuming steps for quality control, alignment, mapping and/or assembly. Therefore, an unmet need exists for methods of processing NGS data for sequence typing that are faster, more reliable, and/or require less computational power without the need for additional time and resources, like for the steps of quality control, alignment, mapping and/or assembly.

The instant disclosure of a method of sequence typing with in silico aptamers from a NGS platform may be designed to address at least some aspects of the problems disclosed above.

### SUMMARY

Briefly described, in a possibly preferred embodiment, the present disclosure overcomes the above-mentioned disadvantages and meets the recognized need for such a method by providing a method of sequence typing with in silico aptamers from a NGS platform. The method of sequence typing with in silico aptamers from a NGS platform of the instant disclosure may generally include a database indexing phase and a sequence variant detection phase. The database indexing phase may include breaking down each of a plurality of input sequences into k-mers, where the k-mers are subsequences of a length k, where the length k is a user defined positive integer, and constructing an enhanced suffix array (ESA) index out of each k-mer from the plurality of input sequences. The sequence variant detection phase may include using an input NGS read file with a plurality of reads. Wherein the sequence variant detection phase may include using the ESA index constructed out of each k-mer from the plurality of input sequences from the database indexing phase for sequence variant detection.

In select embodiments, the database indexing phase further including providing the plurality of input sequences from a user database from the NGS platform, and storing the ESA index on a tangible medium.

In select embodiments, the sequence variant detection phase including providing the input NGS read file with the plurality of reads.

One feature of the instant disclosure may be that the sequence variant detection of the sequence variant detection phase may include an algorithm for sequence variant detection. In select embodiments of the algorithm, for each read in the NGS read file, identifying the middle k-mer and comparing each of the identified middle k-mers against the k-mers of the ESA index. In this embodiment, if the middle k-mer is not present in the ESA index, the read is discarded and the sequence variant detection phase moves to the next read in the input NGS read file. On the other hand, if the middle k-mer is present in the ESA index, then the entire read is broken down into k-mers, and each k-mer of the read is compared to the ESA index and an allele count for each of the plurality of input sequences it matches is provided. After each k-mer of the read is compared to the ESA index and the allele count is provided, the read is discarded and the sequence variant detection phase moves to the next read in the input NGS read file.

Another feature of the method of the instant disclosure is that when all reads from the NGS read file are completed, a list of the reads from the input NGS read file may be created with the highest allele count of k-mers. In select embodiments, each of the reads from the input NGS read with the highest count of k-mers, a k-mer depth at each sequence position may be computed using an interval tree data structure.

In select embodiments, the k-mers may be queried against the ESA index in an iterative manner to identify sequence variants at single nucleotide resolution.

In select embodiments, the k-mer querying may utilize a smart read filter for speed and efficiency.

In select embodiments, the k-mer querying may utilize k-mer depth distributions and counting steps to identify sequence variants.

Another feature of the instant method may be that the identified sequence variants may be used to either determine the presence of specific genes in a sample or to determine the species/strain origin of the sample.

In select embodiments, the method of the instant disclosure may be used for gene identification. As an example, and clearly not limited thereto, for gene identification, the database sequences that have greater than 75% of sequence positions covered may be retained, and genes with the highest k-mer counts may be recorded as present for the sample.

In select embodiments, the method may be used for sequence typing. As an example, and clearly not limited thereto, for sequence typing, the database sequences that have 100% of sequence positions covered, with no local minima in the k-mer depth distribution, may be recorded as present for the sample. In other select examples, and clearly not limited thereto, for sequence typing, all locus-specific allele counts recorded as present may be queried against an allele profile table to yield a final sequence type.

Another feature of the instant disclosure of a method of sequence typing with in silico aptamers from a NGS platform may be that it can be implemented in a computer program.

In another aspect, a computer configured for sequence typing with in silico aptamers from a NGS platform may generally include: providing an ESA index with a plurality of input sequences broken down into k-mers, where the k-mers are subsequences of a length k, where the length k is a user defined positive integer, providing an input NGS read file with a plurality of reads, and detecting sequence variant using the ESA index constructed out of each k-mer from the plurality of input sequences.

In select embodiments, the computer may further include the steps of providing the plurality of input sequences from a user database from the NGS platform, and storing the ESA index on a tangible medium.

In select embodiments, the computer may further include an algorithm for sequence variant detection. In select embodiments of the algorithm, for each read in the NGSread file, identifying the middle k-mer and comparing each of the identified middle k-mers against the k-mers of the ESA index. If the middle k-mer is not present in the ESA index, the read is discarded and the method moves to the next read in the input NGS read file. On the other hand, if the middle k-mer is present in the ESA index, then the entire read is broken down into k-mers, and each k-mer of the read is compared to the ESA index and an allele count for each of the plurality of input sequences it matches is provided. After each k-mer of the read is compared to the ESA index and the allele count is provided, the read may be discarded and the computer may move to the next read in the input NGS read file.

One feature of the instant computer may be that when all reads from the NGS read file are completed, a list of the reads from the input NGS read file may be created with the highest allele count of k-mers.

Another feature of the instant computer may be that for each of the reads from the input NGS read with the highest count of k-mers, a k-mer depth at each sequence position may be computed using an interval tree data structure.

In select embodiments of the computer, the k-mers may be queried against the ESA index in an iterative manner to identify sequence variants at single nucleotide resolution.

In select embodiments of the computer, the k-mer querying may utilize a smart read filter for speed and efficiency.

In select embodiments of the computer, the k-mer querying may utilize k-mer depth distributions and counting steps to identify sequence variants.

In select embodiments of the computer, the identified sequence variants may be used to either determine the presence of specific genes in a sample or to determine the species/strain origin of the sample.

In select embodiments, the computer may be used for gene identification or sequence typing. As an example, and clearly not limited thereto, for gene identification, database sequences that have greater than 75% of sequence positions covered may be retained, and genes with the highest k-mer counts may be recorded as present for the sample. As another example, and clearly not limited thereto, for sequence typing, database sequences that have 100% of sequence positions covered, with no local minima in the k-mer depth distribution, may be recorded as present for the sample. As yet another example, and clearly not limited thereto, for sequence typing, all locus-specific allele counts recorded as present may be queried against an allele profile table to yield a final sequence type.

A feature of the instant disclosure of a method of sequence typing with in silico aptamers from an NGS platform may be its ability to perform gene identification and sequence typing directly from NGS reads without the need for additional time, and resource consuming steps for quality control, alignment, mapping and/or assembly.

Another feature of the present disclosure of a method of sequence typing with in silico aptamers from an NGS platform may be its accuracy, as the instant method may be designed to accurately and unambiguously identify sequence variants at single nucleotide resolution.

Another feature of the present disclosure of a method of sequence typing with in silico aptamers from an NGS platform may be the ability to report previously unknown sequence variants in a sample.

Another feature of the present disclosure of a method of sequence typing with in silico aptamers from an NGS platform may be its speed. The streamlined algorithmic design may allow the method of the instant disclosure to perform gene identification and sequence typing orders of magnitude faster than any existing method.

Another feature of the present disclosure of a method of sequence typing with in silico aptamers from an NGS platform may be its scalability. The algorithm used in the instant method may scales as (n log n), where n is the number of sequences in the databases. This may allow the instant method to be used for so-called super multilocus sequence typing (superMLST) schemes that employ hundreds or thousands of loci.

Another feature of the present disclosure of a method of sequence typing with in silico aptamers from an NGS platform may be its light computational memory footprint. The low memory utilization of the instant method may allow it to run on any modern computer from laptops up to large-scale and high performance computer clusters.

Another feature of the present disclosure of a method of sequence typing with in silico aptamers from an NGS platform may be its underlying ESA data structure implementation. This data structure allows for memory caching so that a single database can be shared across multiple instances of the program, thereby providing for parallelization and enhanced speed.

Another feature of the present disclosure of a method of sequence typing with in silico aptamers from an NGS platform may be its minimal dependencies. The instant method may be packaged with all required libraries and may have no external dependencies. This may allow it to be readily deployed in the field for real-time molecular epidemiology.

Another feature of the present disclosure of a method of sequence typing with in silico aptamers from an NGS platform may be its ease of use. The instant method may perform automatic gene identification or sequence typing directly from unprocessed NGS read files in a single step. Accordingly, the use of the instant method may require minimal computational training and can be executed by public health laboratorians.

Another feature of the present disclosure of a method of sequence typing with in silico aptamers from an NGS platform may be that it can be used for culture-independent diagnostics, including gene identification or sequence typing from mixed infection samples.

The foregoing illustrative summary, as well as other exemplary objectives and/or advantages of the disclosure, and the manner in which the same are accomplished, may become more apparent to one skilled in the art from the prior Summary, and the following Brief Description of the Drawings, Detailed Description, and Claims when read in light of the accompanying Detailed Drawings.

### BRIEF DESCRIPTION OF THE DRAWINGS

The present apparatuses, systems and methods will be better understood by reading the Detailed Description with reference to the accompanying drawings, which are not necessarily drawn to scale, and in which like reference numerals denote similar structure and refer to like elements throughout, and in which:

FIG. 1 is a flow chart that shows select embodiments of the method of sequence typing with in silico aptamers from an NGS platform according to the instant disclosure including select embodiments of the data indexing phase and the sequence variant detection phase.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

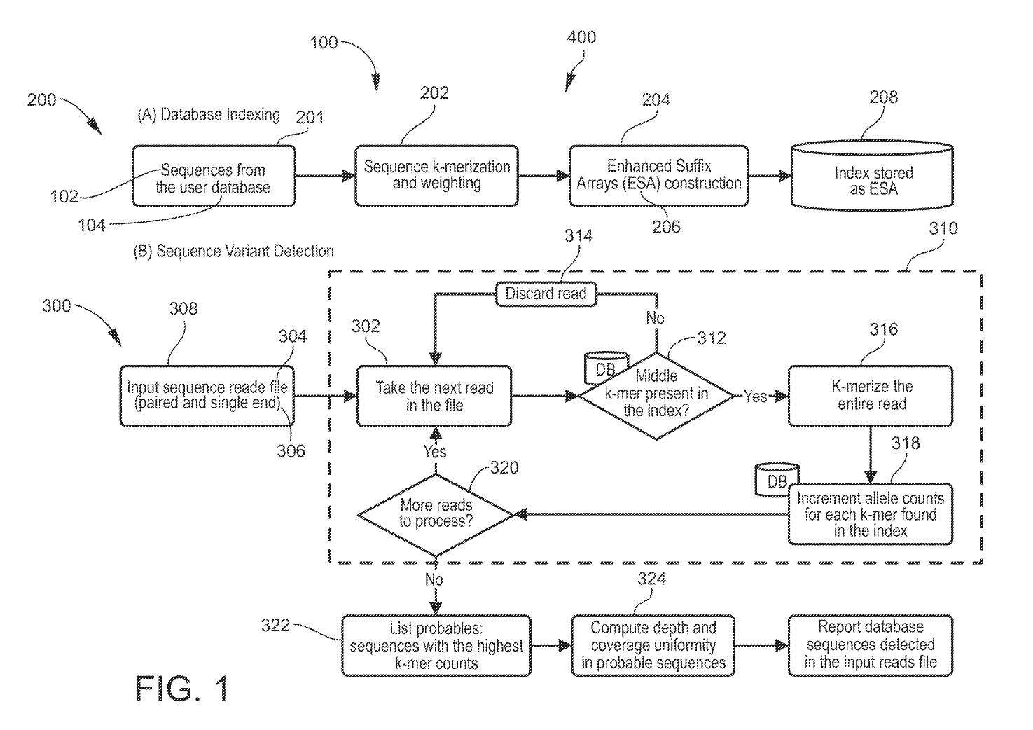

In describing the exemplary embodiments of the present disclosure, as illustrated in FIG. 1, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

A sequence read, as used herein, may refer to a DNA fragment that is read by a sequencing machine. Each sequence read is typically 100-300 bp in length and is stored as a FASTQ file.

A next generation sequencing, or NGS, as used herein, may refer to sequencing machines that were released in the mid-2000s. They perform sequencing in a massively parallel manner using a sequencing by synthesis based paradigm. Current NGS machines include Illumina's MiSeq and HiSeq and IonTorrent. Also referred to as second generation sequencing.

Paired-end sequencing, as used herein, may refer to a type of sequencing technique where both ends of a DNA fragment are sequenced. Commonly employed in Illumina's sequencing machines.

Sequence typing, as used herein, may refer to identifying the specific species/strain type of a microbial sample.

Typing scheme, as used herein, may refer to a scheme that defines the genes and the variants of the genes which are used together to define distinct sequence types. Typing schemes are typically specific for each species.

Multilocus sequence typing (MLST), as used herein, may refer to a traditional sequence typing method that is based on 7-9 housekeeping loci. Widely used in public health and molecular epidemiology.

Sequence database, as used herein, may represent a set of sequences stored in a FASTA format (standard storage format for sequences).

k-mer, as used herein, may refer to a sequence of length k, where k is a positive integer.

k-merization, as used herein, may refer to a computational process of breaking down a sequence into subsequences of length k (k is a positive integer). Given a sequence of length 1, the k-merization process will produce 1-1 overlapping k-mers.

Sequence assembly, as used herein, may refer to a computational method for reconstructing the original genome based on shorter sequence reads.

Sequence alignment, as used herein, may refer to a method of arranging a pair (or more) of sequences in a way to maximize columns with identical or similar characters.

With reference to FIG. 1, the present invention embraces method 100 of sequence typing with in silico aptamers 102 from NGS platform 104. Method 100 of sequence typing with in silico aptamers 102 from NGS platform 104 of the instant disclosure may generally include database indexing phase 200 and sequence variant detection phase 300. The database indexing phase 200 may include step 202 of breaking down each of a plurality of input sequences into k-mers, where the k-mers are subsequences of a length k, where the length k is a user defined positive integer, and step 204 of constructing enhanced suffix array index 206, or ESA index 206, out of each k-mer from the plurality of input sequences. The sequence variant detection phase 300 may include step 302 of using an input NGS read file 304 with a plurality of reads 306. Wherein, the sequence variant detection phase 300 may include using the ESA index 206 constructed out of each k-mer from the plurality of input sequences 102 from the database indexing phase 200 for sequence variant detection 300.

In select embodiments, the database indexing phase 200 may further include step 201 of providing the plurality of input sequences 102 from user database 104 from the NGS platform, and step 208 of storing the ESA index 206 on a tangible medium.

In select embodiments, the sequence variant detection phase 300 may include step 308 of providing the input NGS read file 304 with the plurality of reads 306.

One feature of the instant disclosure may be that the sequence variant detection of the sequence variant detection phase 300 may include algorithm 310 for sequence variant detection. In select embodiments of the algorithm 310, for each read in the NGS read file, step 312 of identifying the middle k-mer and comparing each of the identified middle k-mers against the k-mers of the ESA index 206. In this embodiment, if the middle k-mer is not present in the ESA index, the read is discarded in step 314 and the sequence variant detection phase moves to the next read in the input NGS read file. On the other hand, if the middle k-mer is present in the ESA index, then the entire read is broken down into k-mers in step 316, and each k-mer of the read is compared to the ESA index and an allele count for each of the plurality of input sequences it matches is provided in step 318. After each k-mer of the read is compared to the ESA index and the allele count is provided, the read is discarded and the sequence variant detection phase moves to the next read in the input NGS read file as shown in step 320.

Another feature of the method of the instant disclosure is that when all reads from the NGS read file are completed, a list of the reads from the input NGS read file may be created with the highest allele count of k-mers in step 322. In select embodiments, each of the reads from the input NGS read with the highest count of k-mers, a k-mer depth at each sequence position may be computed using an interval tree data structure, as shown in step 324.

In select embodiments, the k-mers may be queried against the ESA index in an iterative manner to identify sequence variants at single nucleotide resolution.

In select embodiments, the k-mer querying may utilize a smart read filter for speed and efficiency.

In select embodiments, the k-mer querying may utilize k-mer depth distributions and counting steps to identify sequence variants.

Another feature of the instant method may be that the identified sequence variants may be used to either determine the presence of specific genes in a sample or to determine the species/strain origin of the sample.

In select embodiments, the method of the instant disclosure may be used for gene identification. As an example, and clearly not limited thereto, for gene identification, the database sequences that have greater than 75% of sequence positions covered may be retained, and genes with the highest k-mer counts may be recorded as present for the sample.

In select embodiments, the method may be used for sequence typing. As an example, and clearly not limited thereto, for sequence typing, the database sequences that have 100% of sequence positions covered, with no local minima in the k-mer depth distribution, may be recorded as present for the sample. In other select examples, and clearly not limited thereto, for sequence typing, all locus-specific allele counts recorded as present may be queried against an allele profile table to yield a final sequence type.

Another feature of the instant disclosure of a method of sequence typing with in silico aptamers from an NGS platform may be that it can be implemented in a computer program.

Still referring to FIG. 1, in another aspect, computer 400 configured for sequence typing with in silico aptamers from an NGS platform may generally include: providing ESA index 206 with a plurality of input sequences broken down into k-mers, where the k-mers are subsequences of a length k, where the length k is a user defined positive integer, step 308 of providing input NGS read file 304 with a plurality of reads 306, and detecting sequence variant 300 using the ESA index 206 constructed out of each k-mer from the plurality of input sequences.

In select embodiments, the computer 400 may further include the steps of providing 201 the plurality of input sequences 102 from user database 104 from the NGS platform, and storing 208 the ESA index on a tangible medium.

In select embodiments, the computer 400 may further include algorithm 310 for sequence variant detection. In select embodiments of the algorithm 310, for each read in the NGS read file, step 312 of identifying the middle k-mer and comparing each of the identified middle k-mers against the k-mers of the ESA index 206. In this embodiment, if the middle k-mer is not present in the ESA index, the read is discarded in step 314 and the sequence variant detection phase moves to the next read in the input NGS read file. On the other hand, if the middle k-mer is present in the ESA index, then the entire read is broken down into k-mers in step 316, and each k-mer of the read is compared to the ESA index and an allele count for each of the plurality of input sequences it matches is provided in step 318. After each k-mer of the read is compared to the ESA index and the allele count is provided, the read is discarded and the sequence variant detection phase moves to the next read in the input NGS read file as shown in step 320.

One feature of the instant computer 400 may be that when all reads from the NGS read file are completed, a list of the reads from the input NGS read file may be created 322 with the highest allele count of k-mers.

Another feature of the instant computer 400 may be that for each of the reads from the input NGS read with the highest count of k-mers, a k-mer depth at each sequence position may be computed 324 using an interval tree data structure.

In select embodiments of the computer 400, the k-mers may be queried against the ESA index in an iterative manner to identify sequence variants at single nucleotide resolution.

In select embodiments of the computer 400, the k-mer querying may utilize a smart read filter for speed and efficiency.

In select embodiments of the computer 400, the k-mer querying may utilize k-mer depth distributions and counting steps to identify sequence variants.

In select embodiments of the computer 400, the identified sequence variants may be used to either determine the presence of specific genes in a sample or to determine the species/strain origin of the sample.

In select embodiments, the computer 400 may be used for gene identification or sequence typing. As an example, and clearly not limited thereto, for gene identification, database sequences that have greater than 75% of sequence positions covered may be retained, and genes with the highest k-mer counts may be recorded as present for the sample. As another example, and clearly not limited thereto, for sequence typing, database sequences that have 100% of sequence positions covered, with no local minima in the k-mer depth distribution, may be recorded as present for the sample. As yet another example, and clearly not limited thereto, for sequence typing, all locus-specific allele counts recorded as present may be queried against an allele profile table to yield a final sequence type.

A feature of the instant disclosure of method 100 and/or computer 400 configured for sequence typing with in silico aptamers from an NGS platform may be its ability to perform gene identification and sequence typing directly from NGS reads without the need for additional time, and resource consuming steps for quality control, alignment, mapping and/or assembly.

Another feature of the present disclosure of a method 100 and/or computer 400 configured for sequence typing with in silico aptamers from an NGS platform may be its accuracy, as the instant method may be designed to accurately and unambiguously identify sequence variants at single nucleotide resolution.

Another feature of the present disclosure of a method 100 and/or computer 400 configured for sequence typing with in silico aptamers from an NGS platform may be the ability to report previously unknown sequence variants in a sample.

Another feature of the present disclosure of a method 100 and/or computer 400 configured for sequence typing with in silico aptamers from an NGS platform may be its speed. The streamlined algorithmic design (310) may allow the method of the instant disclosure to perform gene identification and sequence typing orders of magnitude faster than any existing method.

Another feature of the present disclosure of a method 100 and/or computer 400 configured for sequence typing with in silico aptamers from NGS platform may be its scalability. The algorithm 310 used in the instant method may scales as (nlogn), where n is the number of sequences in the databases. This may allow the instant method to be used for so-called super multilocus sequence typing (superMLST) schemes that employ hundreds or thousands of loci.

Another feature of the present disclosure of method 100 and/or computer 400 configured for sequence typing with in silico aptamers from an NGS platform may be its light computational memory footprint. The low memory utilization of the instant method 100 and/or computer 400 may allow it to run on any modern computer from laptops up to large-scale and high performance computer clusters.

Another feature of the present disclosure of method 100 and/or computer 400 configured for sequence typing with in silico aptamers from an NGS platform may be its underlying ESA 206 data structure implementation. This data structure 206 may allow for memory caching so that a single database can be shared across multiple instances of the program, thereby providing for parallelization and enhanced speed.

Another feature of the present disclosure of method 100 and/or computer 400 configured for sequence typing with in silico aptamers from an NGS platform may be its minimal dependencies. The instant method 100 and/or computer 400 may be packaged with all required libraries and may have no external dependencies. This may allow it to be readily deployed in the field for real-time molecular epidemiology.

Another feature of the present disclosure of method 100 and/or computer 400 configured for sequence typing with in silico aptamers from an NGS platform may be its ease of use. The instant method 100 and/or computer 400 may perform automatic gene identification or sequence typing directly from unprocessed NGS read files in a single step. Accordingly, the use of the instant method 100 and/or computer 400 may require minimal computational training and can be executed by public health laboratorians.

Another feature of the present disclosure of method 100 and/or computer 400 configured for sequence typing with in silico aptamers from an NGS platform may be that it can be used for culture-independent diagnostics, including gene identification or sequence typing from mixed infection samples.

The present disclosure relates a program, computer, or method designed to perform rapid and automatic microbial typing and gene identification directly from genome sequence data. The program, computer, or method would use algorithm 310 which would converge on answers directly from sequence reads without the need for quality control, alignment, mapping or assembly

The purpose of method 100 and/or computer 400 with algorithm 310 may be to perform rapid and automatic (1) gene identification and (2) microbial typing directly from genome sequence data. Algorithm 310 may be designed to provide extremely rapid, turn-key genome sequence analysis solutions for public health scientists. For gene identification, algorithm 310 processes sequence reads from an NGS platform in order to identify specific genes of interest to the user, including but not limited to virulence factors and antimicrobial resistance genes. The gene identification utility of method 100 and/or computer 400 with algorithm 310 may be designed to facilitate culture-independent diagnostics. For microbial typing, method 100 and/or computer 400 with algorithm 310 processes NGS sequence reads in order to identify the species/strain origin of a microbial sample. Both the gene identification and microbial typing utilities of method 100 and/or computer 400 with algorithm 310 rely on the comparison of NGS reads to manually curated databases, which are bundled with the software and routinely updated.

The method 100 and/or computer 400 rests on algorithm 310 that may be distinct from other software packages that have been designed for similar microbial typing applications. Algorithm 310 may converge on answers directly from sequence reads without the need for additional time- and resource-consuming steps for quality control, alignment, mapping and/or assembly. The streamlined algorithmic design makes method 100 and/or computer 400 with algorithm 310 ideally suited for real-time molecular epidemiology (the branch of medicine that deals with the incidence, distribution, and possible control of diseases and other factors relating to health) applications.

Referring to FIG. 1, database indexing phase 200 may be performed with a user input sequence database. Each sequence in the database is broken down into subsequences of length k (i.e., k-mers), where k is a user defined positive integer. K-mers for each individual sequence in the database are represented as an enhanced suffix array (ESA) index 206. For the purposes of sequence typing, users also input an allele profile-to-sequence type table. Sequence variant detection phase 300 may then be performed with user input NGS read file 304. For each read in the NGS sequence file, the middle k-mer is searched against the ESA index 206. If the middle k-mer is not present in the ESA, the read is discarded and the algorithm 310 moves to the next read. If the k-mer is present in the ESA, then the entire read is broken down into k-mers. Each k-mer for the read is searched against the ESA index 206 and a counter for each database sequence to which it matches is incremented. When this process ends, the read is discarded and the algorithm 310 moves to the next read. When all reads from the file are exhausted, a list of database sequences with the highest k-mer counts is produced. For each of the database sequences with highest k-mer counts, the k-mer depth at each sequence position is computed using an interval tree data structure. For gene identification, database sequences that have >75% of sequence positions covered are retained, and genes with the highest k-mer counts are recorded as present for the sample. For sequence typing, database sequences that have 100% of sequence positions covered, with no local minima in the k-mer depth distribution, are recorded as present for the sample. For sequence typing, all locus-specific alleles recorded as present are queried against an allele profile table to yield a final sequence type.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

1. A method of sequence typing with in silico aptamers from an NGS platform, the method comprising:
a database indexing phase including breaking down each of a plurality of input sequences into k-mers, where the k-mers are subsequences of a length k, where the length k is a user defined positive integer, and constructing an ESA index out of each k-mer from the plurality of input sequences; and
a sequence variant detection phase including using an input NGS read file with a plurality of reads;
wherein the sequence variant detection phase uses the ESA index constructed out of each k-mer from the plurality of input sequences from the database indexing phase for sequence variant detection.

2. The method of claim 1, wherein the database indexing phase further including:
providing the plurality of input sequences from a user database from the NGS platform; and
storing the ESA index on a tangible medium.

3. The method of claim 1, wherein the sequence variant detection phase including:
providing the input NGS read file with the plurality of reads.

4. The method of claim 1, wherein the sequence variant detection of the sequence variant detection phase including an algorithm for sequence variant detection, said algorithm comprising:
for each read in the NGS read file, identifying the middle k-mer and comparing each of the identified middle k-mers against the k-mers of the ESA index;
if the middle k-mer is not present in the ESA index, the read is discarded and the sequence variant detection phase moves to the next read in the input NGS read file;
if the middle k-mer is present in the ESA index, then:
the entire read is broken down into k-mers;
each k-mer of the read is compared to the ESA index and an allele count for each of the plurality of input sequences it matches is provided;
after each k-mer of the read is compared to the ESA index and the allele count is provided, the read is discarded and the sequence variant detection phase moves to the next read in the input NGS read file;
when all reads from the NGS read file are completed, a list of the reads from the input NGS read file is created with the highest allele count of k-mers.

5. The method of claim 4, wherein for each of the reads from the input NGS read with the highest count of k-mers, a k-mer depth at each sequence position is computed using an interval tree data structure.

6. The method according to claim 4, wherein the k-mers are queried against the ESA index in an iterative manner to identify sequence variants at single nucleotide resolution.

7. The method according to claim 6, wherein the k-mer querying utilizes a smart read filter for speed and efficiency.

8. The method according to claim 6, wherein the k-mer querying utilizes k-mer depth distributions and counting steps to identify sequence variants.

9. The method according to claim 1, wherein identified sequence variants are used to either determine the presence of specific genes in a sample or to determine the species/strain origin of the sample.

10. The method according to claim 1, wherein the method being used for gene identification.

11. The method according to claim 10, wherein for gene identification, database sequences that have greater than 75% of sequence positions covered are retained, and genes with the highest k-mer counts are recorded as present for the sample.

12. The method according to claim 1, wherein the method being used for sequence typing.

13. The method according to claim 12, wherein for sequence typing, database sequences that have 100% of sequence positions covered, with no local minima in the k-mer depth distribution, are recorded as present for the sample.

14. The method according to claim 12, wherein for sequence typing, all locus-specific allele counts recorded as present are queried against an allele profile table to yield a final sequence type.

15. The method according to claim 1, wherein the method being implemented in a computer program.

16. A method of sequence typing with in silico aptamers from an NGS platform, the method comprising:
a database indexing phase including:
providing a plurality of input sequences from a user database from the NGS platform;
breaking down each of the plurality of input sequences into k-mers, where the k-mers are subsequences of a length k, where the length k is a user defined positive integer;
constructing an ESA index out of each k-mer from the plurality of input sequences; and
storing the ESA index on a tangible medium; and
a sequence variant detection phase including:
providing an input NGS read file with a plurality of reads;
using the input NGS read file with the plurality of reads for sequence variant detection including an algorithm configured for sequence variant detection, wherein said algorithm comprising:
for each read in the NGS read file, identifying the middle k-mer and comparing each of the identified middle k-mers against the k-mers of the ESA index;
if the middle k-mer is not present in the ESA index, the read is discarded and the sequence variant detection phase moves to the next read in the input NGS read file;
if the middle k-mer is present in the ESA index, then:
the entire read is broken down into k-mers;
each k-mer of the read is compared to the ESA index and an allele count for each of the plurality of input sequences it matches is provided;
after each k-mer of the read is compared to the ESA index and the allele count is provided, the read is discarded and the sequence variant detection phase moves to the next read in the input NGS read file;
when all reads from the NGS read file are completed, a list of the reads from the input NGS read file is created with the highest allele count of k-mers;
wherein for each of the reads from the input NGS read with the highest count of k-mers, a k-mer depth at each sequence position is computed using an interval tree data structure;
wherein the k-mers are queried against the ESA index in an iterative manner to identify sequence variants at single nucleotide resolution;
wherein the k-mer querying utilizes a smart read filter for speed and efficiency;
wherein the k-mer querying utilizes k-mer depth distributions and counting steps to identify sequence variants;
wherein identified sequence variants are used to either determine the presence of specific genes in a sample or to determine the species/strain origin of the sample;
wherein the method being used for gene identification or sequence typing;
wherein for gene identification, database sequences that have greater than 75% of sequence positions covered are retained, and genes with the highest k-mer counts are recorded as present for the sample;
wherein for sequence typing, database sequences that have 100% of sequence positions covered, with no local minima in the k-mer depth distribution, are recorded as present for the sample;
wherein for sequence typing, all locus-specific allele counts recorded as present are queried against an allele profile table to yield a final sequence type; and
wherein the method being implemented in a computer program.

17. A computer configured for sequence typing with in silico aptamers from a NGS platform, the computer comprising:
providing an ESA index with a plurality of input sequences broken down into k-mers, where the k-mers are subsequences of a length k, where the length k is a user defined positive integer;
providing an input NGS read file with a plurality of reads; and
detecting sequence variant using the ESA index constructed out of each k-mer from the plurality of input sequences.

18. The computer of claim 17 further including:
providing the plurality of input sequences from a user database from the NGS platform; and
storing the ESA index on a tangible medium.

19. The computer of claim 17, further including an algorithm for sequence variant detection, said algorithm comprising:
for each read in the NGS read file, identifying the middle k-mer and comparing each of the identified middle k-mers against the k-mers of the ESA index;
if the middle k-mer is not present in the ESA index, the read is discarded and the computer moves to the next read in the input NGS read file;
if the middle k-mer is present in the ESA index, then:
the entire read is broken down into k-mers;
each k-mer of the read is compared to the ESA index and an allele count for each of the plurality of input sequences it matches is provided;
after each k-mer of the read is compared to the ESA index and the allele count is provided, the read is discarded and the computer moves to the next read in the input NGS read file;
when all reads from the NGS read file are completed, a list of the reads from the input NGS read file is created with the highest allele count of k-mers.

20. The computer of claim 19, wherein:
for each of the reads from the input NGS read with the highest count of k-mers, a k-mer depth at each sequence position is computed using an interval tree data structure;
wherein the k-mers are queried against the ESA index in an iterative manner to identify sequence variants at single nucleotide resolution;
wherein the k-mer querying utilizes a smart read filter for speed and efficiency;
wherein the k-mer querying utilizes k-mer depth distributions and counting steps to identify sequence variants;
wherein identified sequence variants are used to either determine the presence of specific genes in a sample or to determine the species/strain origin of the sample;
wherein the computer being used for gene identification or sequence typing;
wherein for gene identification, database sequences that have greater than 75% of sequence positions covered are retained, and genes with the highest k-mer counts are recorded as present for the sample;
wherein for sequence typing, database sequences that have 100% of sequence positions covered, with no local minima in the k-mer depth distribution, are recorded as present for the sample; and
wherein for sequence typing, all locus-specific allele counts recorded as present are queried against an allele profile table to yield a final sequence type.
